(19) United States
(12) Patent Application Publication
(10) Pub. No.: US 2015/0365828 A1
(43) Pub. Date: Dec. 17, 2015

(54) COMMUNICATION TERMINAL, COMMUNICATION METHOD, PROGRAM, COMMUNICATION SYSTEM, AND INFORMATION PROCESSING APPARATUS

(71) Applicant: NEC CORPORATION, Minato-ku, Tokyo (JP)

(72) Inventors: Yoshinori SAIDA, Tokyo (JP); Shuichi KARINO, Tokyo (JP); Yoshikazu WATANABE, Tokyo (JP); Gen MORITA, Tokyo (JP); Takahiro IIHOSHI, Tokyo (JP)

(21) Appl. No.: 14/762,549

(22) PCT Filed: Jan. 31, 2014
(86) PCT No.: PCT/JP2014/052228

§ 371 Date: Jul. 22, 2015

(30) Foreign Application Priority Data
Jan. 31, 2013 (JP) 2013-016416

(51) Int. Cl. H04W 12/08; H04W 48/18

(52) U.S. Cl. CPC H04W 12/08; H04W 48/18; H04W 88/06

(57) ABSTRACT

A communication terminal that can communicate through a plurality of communication schemes. The terminal comprises: a plurality of communication interfaces that correspond to at least one of the plurality of communication schemes; and a communication unit that stores a plurality of communication policies associated respectively with a plurality of applications, and that selects, from the plurality of communication interfaces, a communication interface(s) to be used in communication performed respectively by the plurality of applications, in accordance with the plurality of communication policies that include a condition(s) identifying of a usage mode of the communication.

This application is a National Stage Entry of PCT/JP2014/052228 filed on Jan. 31, 2014, which claims priority from Japanese Patent Application 2013-016416 filed on Jan. 31, 2013, the contents of all of which are incorporated herein by reference, in their entirety.

### TECHNICAL FIELD

### Cross-Reference to Related Applications

The present invention claims priority from Japanese Patent Application No. 2013-016416 (filed on Jan. 31, 2013), the content of which is hereby incorporated in its entirety by reference into this specification. The present invention relates to a communication terminal, a communication method, a program, a communication system, and an information processing apparatus, and relates to a communication terminal, a communication method, a program, a communication system, and an information processing apparatus, that can communicate via a plurality of communication interfaces.

### BACKGROUND

In recent years there is an increased interest in BYOD (Bring Your Own Device), where devices such as smartphones that are privately owned by employees are used at work. With BYOD, an employee uses his or her privately owned terminal both for work and for private use.

Patent Literature 1 discloses technology by which a judgment is made as to whether or not a VPN (Virtual Private Network) connection is required, in accordance with whether or not a terminal is connected to an internal network (that is, an in-company network).

Patent Literature 2 discloses technology for selecting a wireless LAN (Local Area Network) base station to which a terminal connects, in accordance with an encryption method supported by the wireless LAN base station.
Patent Literature 1:

International Publication No. WO2012/132697
Patent Literature 2:

Japanese Patent Kokai Publication No. JP2004-229190A

### SUMMARY

Patent Literature 1 discloses technology by which a terminal for work usage is connected from an external network to an in-company network, but does not disclose technology for appropriately using a privately owned terminal for work-related use or for private use. Therefore, it is difficult to realize communication control for appropriately using a privately owned terminal for work-related use or for private use, based on the technology disclosed by Patent Literature 1.

Patent Literature 2 discloses technology related to switching among a plurality of wireless LAN base stations, that is, switching base stations within the same RAT (Radio Access Technology) area. However, Patent Literature 2 does not disclose anything concerning a terminal that can communicate through a plurality of RATs. Therefore, it is difficult to realize communication control by a terminal that can communicate through a plurality of RATs, for work-related use or for private use as appropriate, based on the technology disclosed by Patent Literature 2.

Accordingly, there is a demand for technology to use a terminal that can communicate through a plurality of RATs, for work-related use or for private use as appropriate.

According to a first aspect of the present invention, there is provided a communication terminal that can communicate through a plurality of communication schemes, the terminal comprising: a plurality of communication interfaces that correspond to at least one of the plurality of communication schemes; and a communication unit that stores a plurality of communication policies associated respectively with a plurality of applications, and that selects, from the plurality of communication interfaces, a communication interface(s) to be used in communication performed respectively by the plurality of applications, in accordance with the plurality of communication policies that include a condition(s) identifying of a usage mode of the communication.

According to the present invention, there is provided a communication method, by a communication terminal that comprises a plurality of communication interfaces corresponding to at least one of a plurality of communication schemes, the method comprising: referring to a plurality of communication policies associated respectively with a plurality of applications; and selecting, from the plurality of communication interfaces, a communication interface(s) to be used in communication performed respectively by the plurality of applications, in accordance with the plurality of communication policies that include a condition(s) identifying of a usage mode of the communication.

According to the present invention, there is provided a program, causing a communication terminal that comprises a plurality of communication interfaces corresponding to at least one of a plurality of communication schemes to execute: referring to a plurality of communication policies associated respectively with a plurality of applications, and selecting, from the plurality of communication interfaces, a communication interface(s) to be used in communication performed respectively by the plurality of applications, in accordance with the plurality of communication policies that include a condition(s) identifying a usage mode of the communication.

According to the present invention, there is provided a communication system, including a communication terminal that can communicate through a plurality of communication schemes, wherein the communication terminal comprises: a plurality of communication interfaces that correspond to at least one of the plurality of communication schemes; and a communication unit that stores a plurality of communication policies associated respectively with a plurality of applications, and that selects, from the plurality of communication interfaces, a communication interface(s) to be used in communication performed respectively by the plurality of applications, in accordance with the plurality of communication policies that include a condition(s) identifying of a usage mode of the communication.

According to the present invention, there is provided an information processing apparatus that can communicate with a communication terminal that comprises a plurality of communication interfaces corresponding to at least one of a plurality of communication schemes, the information processing apparatus comprising: a storage unit that stores a plurality of communication policies associated respectively with a plurality of applications that operate on the communication terminal, and a control unit that generates an instruction for causing the communication terminal to execute selecting, from the plurality of communication interfaces, a communication interface(s) to be used in communication performed respectively by the plurality of applications, in accordance with the plurality of communication policies that include a condition(s) identifying of a usage mode of the communication.

The present invention provides the following advantage, but not restricted thereto. According to the communication terminal, the communication method, the program, the communication system, and the information processing apparatus of the present invention, it is possible to appropriately use a terminal that can communication by a plurality of RATs, for work-related use and for private use.

### BRIEF DESCRIPTION OF THE DRAWINGS

FIG. 1 shows an example of a communication system in a first exemplary embodiment of the present invention.

FIG. 2 shows an example of a configuration of a communication terminal of the invention.

FIG. 3 shows an example of communication policies of the invention.

FIG. 4 is a flowchart showing an operational example of the first exemplary embodiment of the present invention.

FIG. 5 shows an example of communication policies in a second exemplary embodiment of the present invention.

FIG. 6 shows an example of communication policies in the second exemplary embodiment of the invention.

FIG. 7 shows an example of communication policies in a third exemplary embodiment of the invention.

FIG. 8 shows an example of communication policies in the third exemplary embodiment of the invention.

FIG. 9 shows an example of a communication system in a fourth exemplary embodiment of the present invention.

FIG. 10 shows an example of communication policies in the fourth exemplary embodiment of the invention.

FIG. 11 shows an example of communication policies in a fifth exemplary embodiment of the invention.

FIG. 12 shows an example of a communication policy in a sixth exemplary embodiment of the invention.

FIG. 13 shows an example of a communication system in a seventh exemplary embodiment of the invention.

FIG. 14 shows a configuration example of a policy control server in the seventh exemplary embodiment of the invention.

FIG. 15 shows an example of related technology in an eighth exemplary embodiment of the invention.

FIG. 16 shows an example of related technology in the eighth exemplary embodiment of the invention.

FIG. 17 shows an example of a communication system in the eighth exemplary embodiment of the invention.

FIG. 18 shows a configuration example of a communication terminal in the eighth exemplary embodiment of the invention.

FIG. 19 shows a configuration example of a control server in the eighth exemplary embodiment of the invention.

FIG. 20 shows a configuration example of the eighth exemplary embodiment of the invention.

FIG. 21 shows a configuration example of a virtual switch in the eighth exemplary embodiment of the invention.

### PREFERRED MODES

In the present disclosure, there are various possible modes, which include the following, but not restricted thereto.

### First Exemplary Embodiment

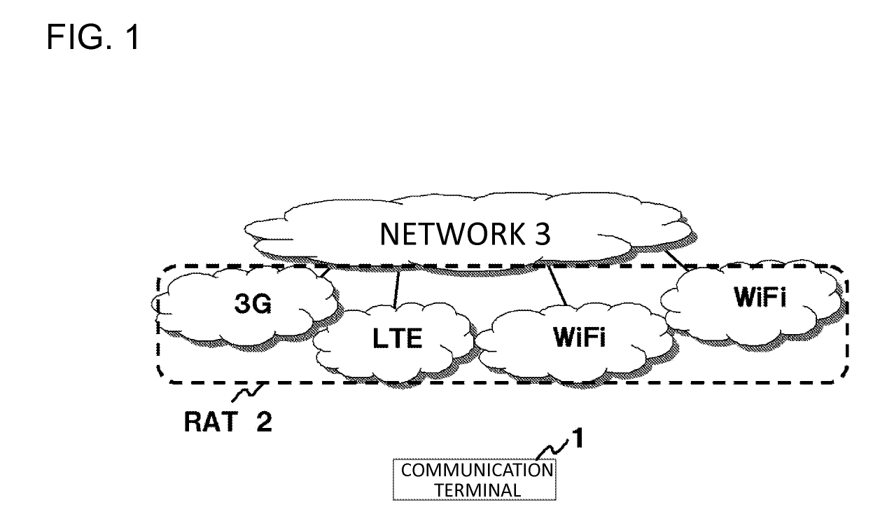

A description is given of a first exemplary embodiment of the present invention, making reference to the drawings. A communication system according to the first exemplary embodiment of the invention includes a communication terminal 1, a RAT 2 and a network 3, as shown in FIG. 1. It is to be noted that reference symbols in the drawings attached to the exemplary embodiment are added to respective elements for convenience as examples in order to aid understanding, and are not intended to limit the present invention to modes illustrated in the drawings.

The communication terminal 1 of the invention can communicate through a plurality of communication schemes (RAT), and has a plurality of communication interfaces corresponding to at least one of the communication schemes. The communication terminal 1 can select a communication interface to be used in communication performed by respective applications, in accordance with a communication policy associated with each of the applications. Therefore, the communication terminal 1 can flexibly use, as appropriate, a communication scheme to be used in communication, in accordance with a communication policy associated with an application. Since the communication terminal can select a communication interface in accordance with a communication policy that includes condition(s) related to identifying a communication usage mode (for example, work-related use or private use), a terminal user can easily use a privately owned communication terminal 1 as appropriate, for work-related communication or for private communication.

The communication terminal 1 can communicate according to a plurality of communication schemes (RAT). The communication terminal 1 is, for example, a device having communication functionality, such as a mobile telephone, a smart phone, a personal computer, or a mobile router. A mobile router is, for example, a terminal that relays a mobile telephone 3G (Third Generation) line or a wireless LAN network.

The RAT 2 is a wireless access network for the communication terminal 1 to connect to the network 3. For example, the RAT 2 includes wireless access networks such as LTE (Long Term Evolution) and WiMAX (Worldwide Interoperability for Microwave Access). RAT 2 also includes in-company LANs (Local Area Network) and the like.

The communication terminal 1 communicates with public networks such as the Internet, and communication networks held by communication carriers, via the RAT 2.

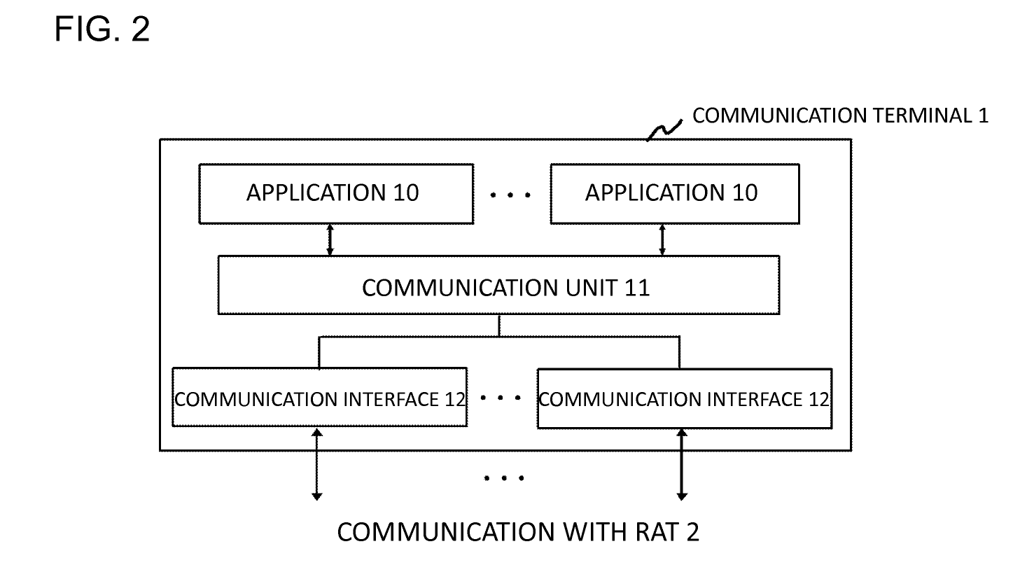

FIG. 2 shows an example of a configuration of the communication terminal 1.

The communication terminal 1 includes a communication unit 11 and a plurality of communication interfaces 12.

A communication interface 12 is, for example, an antenna. Each of the communication interfaces 12 corresponds to at least one of the plurality of RATs. For example, a communication interface 12 corresponds to a specific RAT (for example, WiFi), and the communication terminal 1 is connected to the specific RAT (for example, WiFi) via the communication interface 12 in question. For example, a communication interface 12 corresponds to a plurality of RATs (for example, 3G and LTE), and the communication terminal 1 is connected to any of the plurality of RATs that corresponds thereto, via the communication interface 12 in question.

Each application 10 operated by the communication terminal is assigned to a communication interface 12 to be used for communication by the communication unit 11, and communicates with a network via a RAT 2 corresponding to the assigned communication interface 12.

The communication unit 11 can select a communication interface 12 to be used in communication performed by each application 10, in accordance with a communication policy.

The communication unit 11, for example, has information related to a communication policy associated with each of a plurality of applications. The communication policies include, for example, conditions for identifying communication usage modes. The communication unit 11 can select the communication interface to be used in communication performed by each application, in accordance with the relevant communication policy.

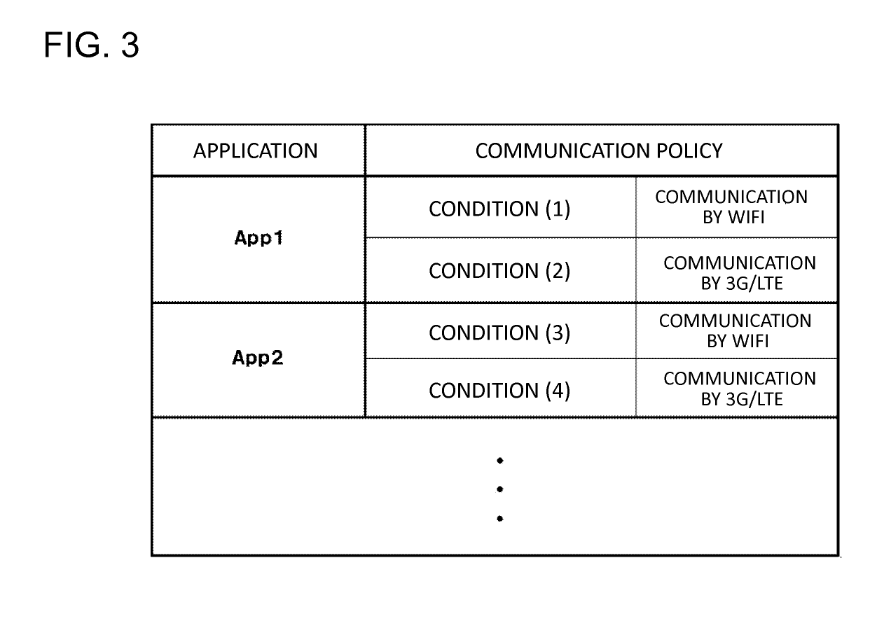

FIG. 3 shows an example of information related to communication policies held by the communication unit 11.

The communication unit 11 associates information related to the communication policies with the respective applications and makes a record thereof. For example, the communication unit 11 associates information related to communication policies with individual applications such as a Web browser or mail software, and makes a record thereof. The communication unit 11 may also associate information related to communication policies with an application group having similar functionality, and make a record thereof. For example, the communication unit 11 associates information related to communication policies with an application group for Web browsing, or an application group for an SNS (Social Networking Service), and makes a record thereof.

The communication policies include, for example, conditions for identifying communication usage modes. A communication usage mode represents, for example, work-related communication or communication for private use. Therefore, the communication terminal 1, for example, can identify whether communication used by respective applications is work-related or is for private use, according to communication policy. As a condition for identifying communication usage mode, the communication policy, for example, prescribes information related to a destination of communication.

The communication policy prescribes a communication scheme (RAT) to be selected, for each condition. In the example of FIG. 3, in a case where communication by an application “App1” matches condition (1), the communication unit 11 selects a communication interface 12 corresponding to WiFi.

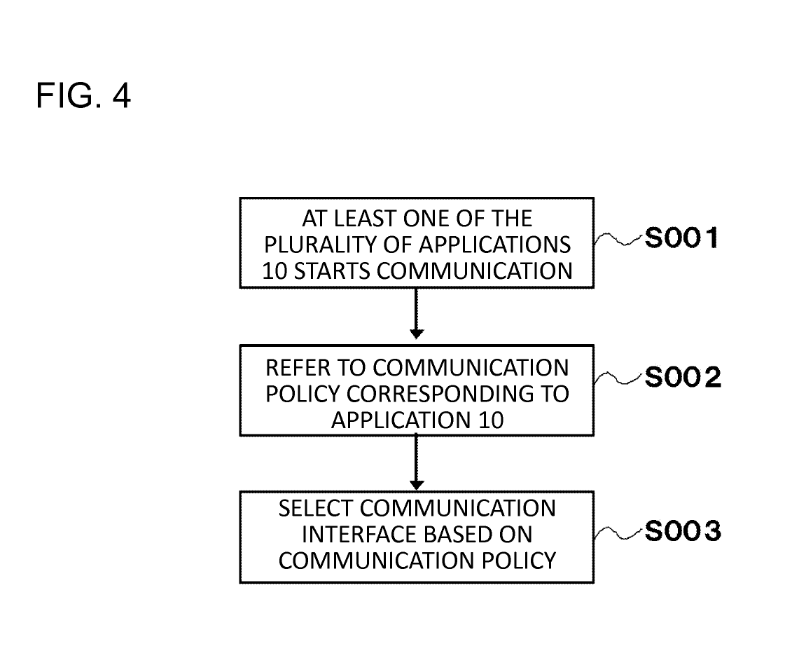

FIG. 4 is a flowchart showing an operational example of the first exemplary embodiment of the present invention.

When at least one of a plurality of applications 10 starts communication (step S001), the communication unit 11 refers to a communication policy associated with the relevant application 10 (step S002).

The communication unit 11 selects the communication interface 12 corresponding to the relevant communication scheme, based on the communication scheme corresponding to the condition matched in communication by the application 10 (step S003).

### Second Exemplary Embodiment

A description is given of a second exemplary embodiment of the present invention, making reference to the drawings. In the second exemplary embodiment, specific examples of communication policies are illustrated.

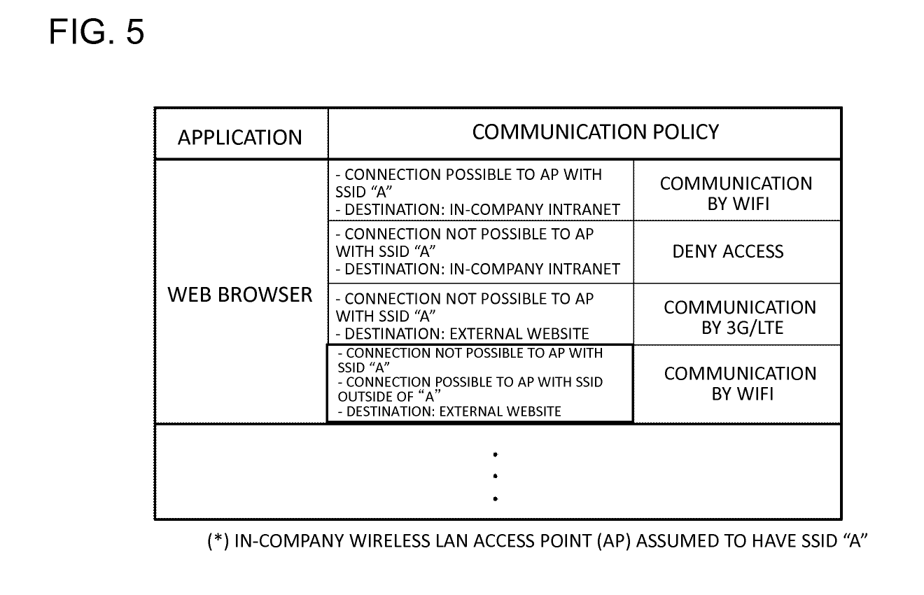

FIG. 5 shows an example of communication policies when an application is a Web browser. In the example of FIG. 5, the communication unit 11 refers to communication policies, and selects a communication interface 12 to be used, based on a condition prescribed by an SSID (Service Set Identifier) of an access point of a wireless LAN, and a communication destination address.

In the example of FIG. 5, the SSID of the access point (AP) for accessing an in-company intranet is assumed to be “A.” It is to be noted that in the following description, the SSID of the access point (AP) for accessing an in-company intranet is assumed to be “A” for other exemplary embodiments also.

The communication unit 11 selects a communication interface based on a prescribed condition as to whether or not a connection to the access point for accessing the in-company intranet is possible, and whether or not the communication destination is to the in-company intranet.

For example, in a case where connection to an access point with SSID of “A” is possible, and the communication destination is to the in-company intranet, the communication unit 11 identifies the relevant communication usage mode as “work-related communication from the office.” In this case, the communication unit 11 selects the communication interface 12 corresponding to WiFi, and executes communication via the access point to the in-company intranet. For example, in a case where connection to an access point with SSID of “A” is not possible, and the communication destination is to the in-company intranet, the communication unit 11 identifies the relevant communication usage mode as “work-related communication from outside the office.” In this case, the communication unit 11, for example, denies access to the in-company intranet by the communication in question.

In a case where the communication destination is an external Web site, for example, the communication unit 11 selects a communication interface 12 corresponding to either WiFi or 3G/LTE, in accordance with whether or not connection is possible to an arbitrary access point with an SSID outside of “A.”

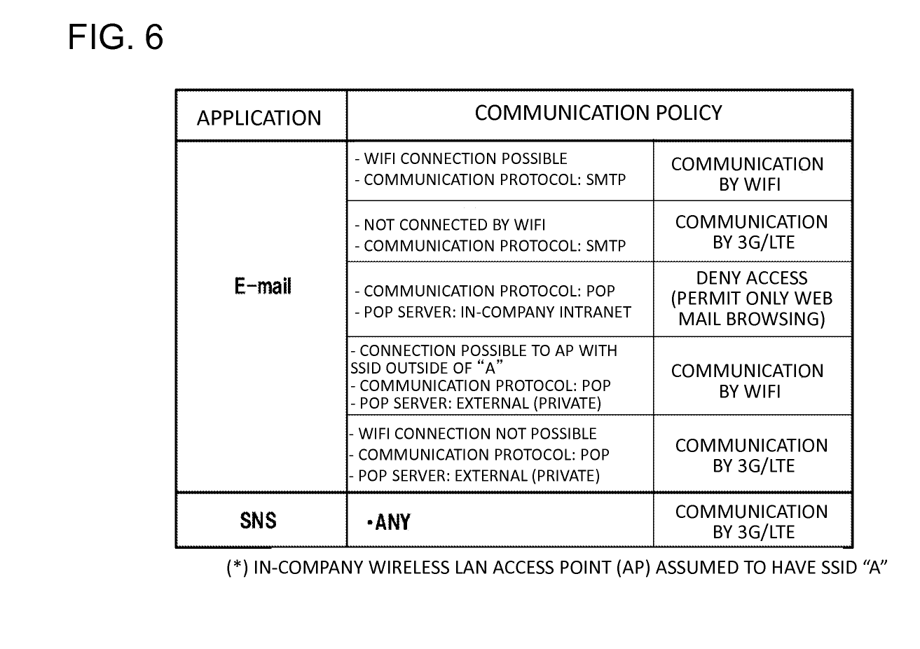

FIG. 6 shows another specific example of communication policies.

Where an application is E-mail software, the communication unit 11 refers to a communication policy and selects a communication interface 12 to be used based on a condition prescribed according whether or not a WiFi connection is possible, a communication protocol, and a communication access destination.

In a case where the communication protocol according to the E-mail software is SMTP (Simple Mail Transfer Protocol) (that is, a case of “mail transmission”) for example, the communication unit permits communication irrespective of whether or not the communication is work-related. In this case, the communication unit 11, for example, selects a communication interface 12 corresponding to WiFi if a connection by WiFi is possible, and selects a communication interface 12 for cellular communication such as 3G or LTE if connection by WiFi is not possible.

In a case where the communication protocol according to the E-mail software is POP (Post Office Protocol, that is, receiving inbound mail) and a POP server at an access destination is an in-company intranet, for example, the communication unit 11 rejects mail reception by POP. According to the communication policy, a company administrator can prevent work-related mail data being accepted by a privately owned communication terminal 1. It is to be noted that in this case, for example, with regard to browsing of work-related mail, browsing by Web mail only may be permitted.

If a POP server at an access destination is an external server, for example, the communication unit 11 identifies the relevant communication usage mode as “private mail use.” In this case, the communication unit 11 selects a communication interface 12 corresponding to either WiFi or 3G/LTE, in accordance with whether or not connection is possible to an arbitrary access point with an SSID outside of “A.”

For a prescribed application (SNS in the example in FIG. 6), for example, the communication unit 11 may select a predetermined communication interface 12 (3G/LTE in the example in FIG. 6), regardless of conditions.

### Third Exemplary Embodiment

A description is given of a third exemplary embodiment of the present invention, making reference to the drawings. In the third exemplary embodiment, a user state is included as a condition for communication policy. The user state is a condition for identifying whether or not the user of the communication terminal 1 is at work. By referring to a communication policy that includes the user state, the communication terminal 1 can more accurately judge whether or not the user is at work and can identify a communication usage mode.

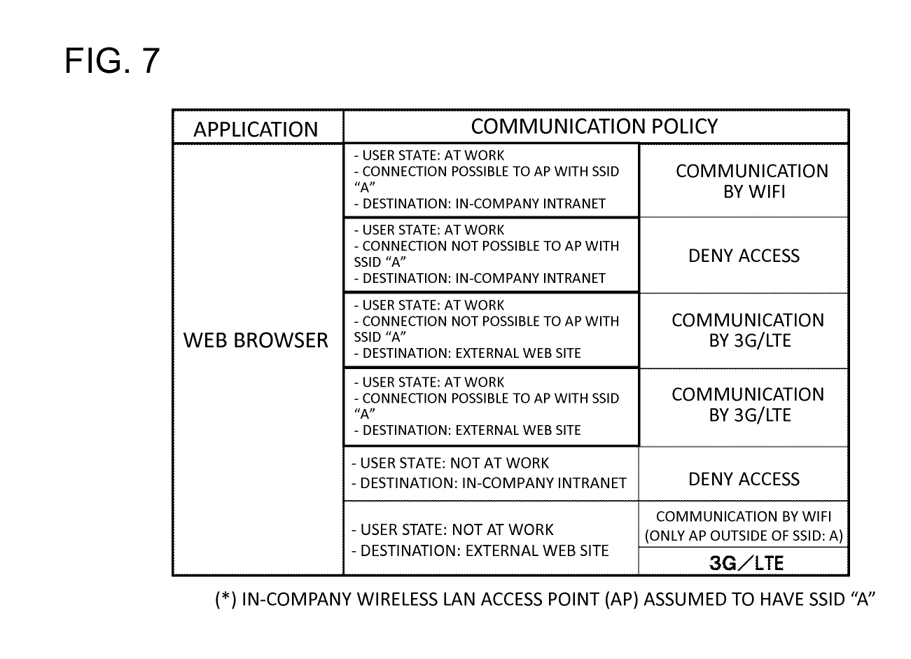

FIG. 7 shows an example of a communication policy in the third exemplary embodiment.

In the example of FIG. 7, the conditions for communication policies include the user state. A parameter representing the user state is, for example, the time or the location of the communication terminal 1. If the time is during work hours, it can be assumed that the user of the communication terminal 1 is at work. If the location of the communication terminal 1 is inside the office of a company, it can be assumed that the user of the communication terminal 1 is at work. In addition, if the time is during work hours and the location of the terminal is inside an office, the degree of accuracy of the estimation that the user is at work, increases.

In the example of FIG. 7, since cases outside of where the communication policy includes the user state are similar to the example of FIG. 5, a detailed description is omitted. For example, in a case where the user state is outside of work, and a communication destination is an external Web site, the communication unit 11 selects a communication interface 12 corresponding to either WiFi or 3G/LTE, in accordance with whether or not connection is possible to an arbitrary access point with an SSID outside of “A.”

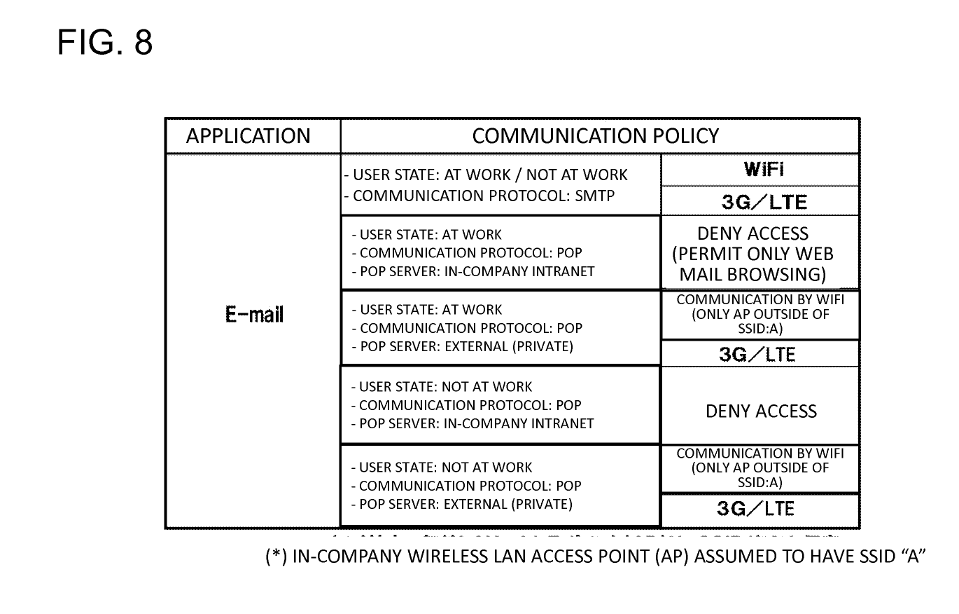

In the example of FIG. 8, since cases outside of where the communication policy includes the user state are similar to the example of FIG. 6, a detailed description is omitted. For example, in a case where the user state is outside of work and E-mail software accesses an external POP server, a communication interface 12 corresponding to either WiFi or 3G/LTE is selected in accordance with whether or not connection is possible to an arbitrary access point with an SSID outside of “A.”

### Fourth Exemplary Embodiment

A description is given of a fourth exemplary embodiment of the present invention, making reference to the drawings. In the fourth exemplary embodiment, a communication terminal 1 establishes a VPN connection in accordance with a communication policy. Since the communication terminal 1 can establish a VPN connection in accordance with the communication policy, a user of the communication terminal 1 can ensure security when using a privately owned terminal for work-related use, without performing a particular operation. It is to be noted that in the fourth exemplary embodiment, VPN is exemplified as a communication for ensuring security, but communication for ensuring security is not limited to VPN.

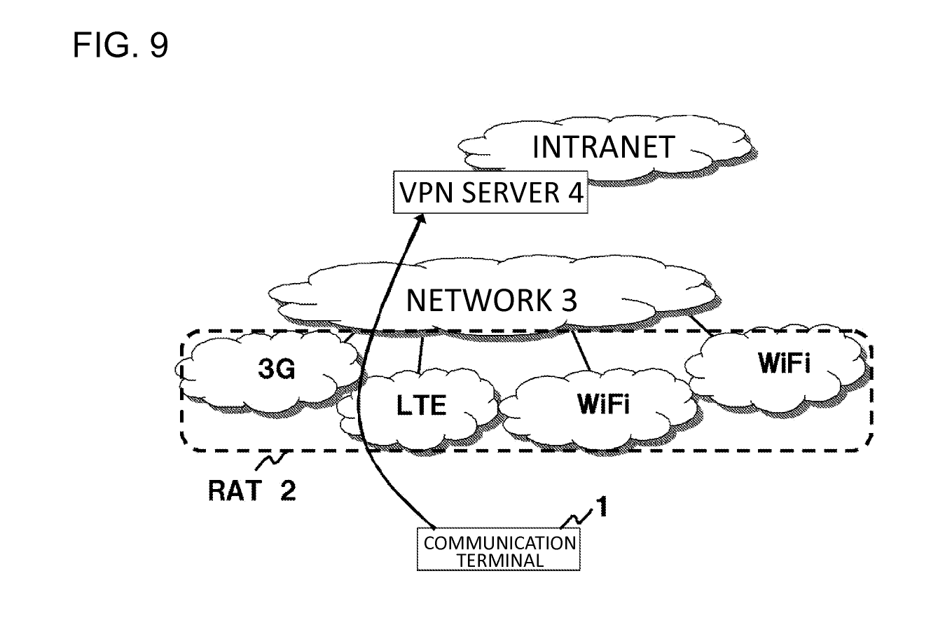

FIG. 9 shows a configuration example of a communication system in the fourth exemplary embodiment.

In FIG. 9, in a case of performing work-related communication from outside to an in-company intranet, for example, the communication terminal 1 establishes a VPN connection via a VPN server 4.

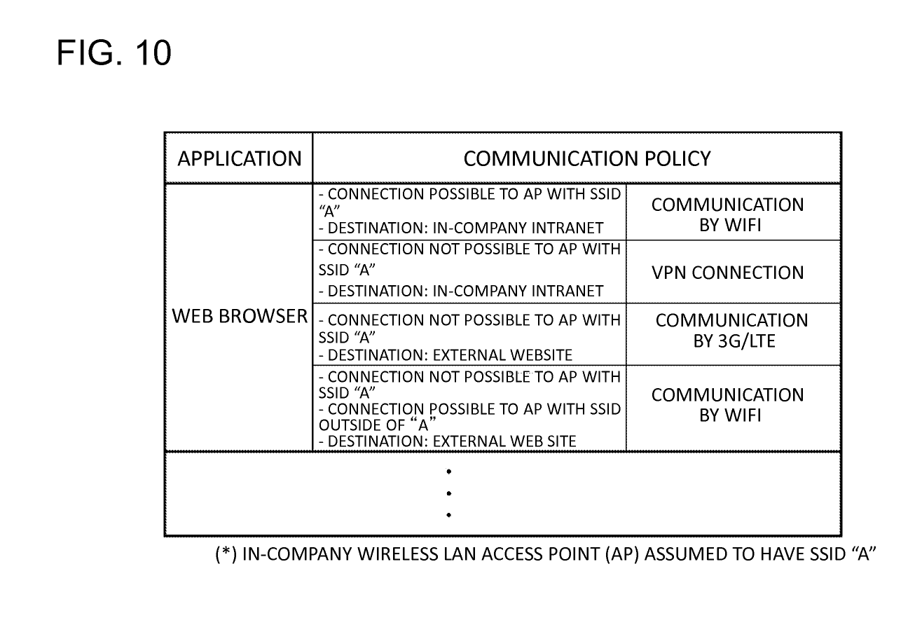

FIG. 10 shows an example of communication policies in the fourth exemplary embodiment. The communication policies of the fourth exemplary embodiment illustrate cases where a VPN communication is required for communication matching a prescribed condition.

FIG. 10 shows an example of a case where an application is a Web browser. In the example of FIG. 10, since cases outside of where the communication policy specifies a VPN communication are similar to the examples of FIG. 5 or FIG. 7, a detailed description is omitted. For example, in a case where connection to an access point with SSID of “A” is not possible and the communication destination is to an in-company intranet, the communication unit 11 identifies the relevant communication usage mode as “work-related communication from outside the company.” In this case the communication unit 11, for example, establishes a VPN connection via either a WiFi communication or 3G/LTE cellular communication from an access point outside the company, and accesses an in-company intranet.

### Fifth Exemplary Embodiment

A description is given of a fifth exemplary embodiment of the present invention, making reference to the drawings. In the fifth exemplary embodiment, a communication policy prescribes a communication scheme (RAT) to be selected based on a requirement (communication security, stability, etc.) required by respective applications. In the fifth exemplary embodiment, the communication terminal 1 can execute communication suitable to the requirement as required by respective applications.

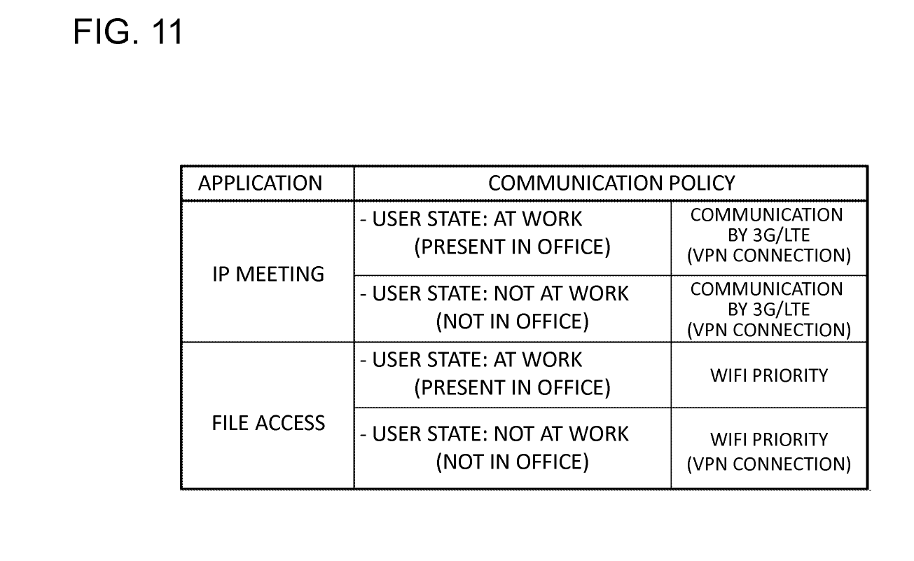

FIG. 11 shows an example of communication policies in the fifth exemplary embodiment.

In the example of FIG. 11, in a case where the communication terminal 1 uses an IP (Internet Protocol) meeting application, for example, even if a WiFi connection is possible, in order to ensure communication stability, which is a requirement of the application, a communication unit 11 selects 3G/LTE cellular communication, with which stable communication can be expected. For example, from a user state, even if the user is in an office and a connection to an in-company access point is possible, the communication unit 11 selects cellular communication, with which stable communication can be expected. In this case, the communication unit 11 may select the cellular communication and may also establish a VPN connection.

In a case where the communication terminal 1 uses an application for file access, for example, the communication unit 11 selects a WiFi connection with priority, with which high speed communication can be expected. For example, from the user state, even if the user is outside the office and connection to an in-company access point is not possible, the communication unit 11 connects to an external access point, and accesses an in-company file server via VPN. In a case where the user is in the office, for example, the communication unit 11 accesses the file server by WiFi connection by an in-company WiFi access point.

### Sixth Exemplary Embodiment

A description is given of a sixth exemplary embodiment of the present invention, making reference to the drawings. In the sixth exemplary embodiment, a communication terminal 1 can shut off malware communication outside of permitted communication, and can improve security in a case of using a privately owned terminal for work-related use.

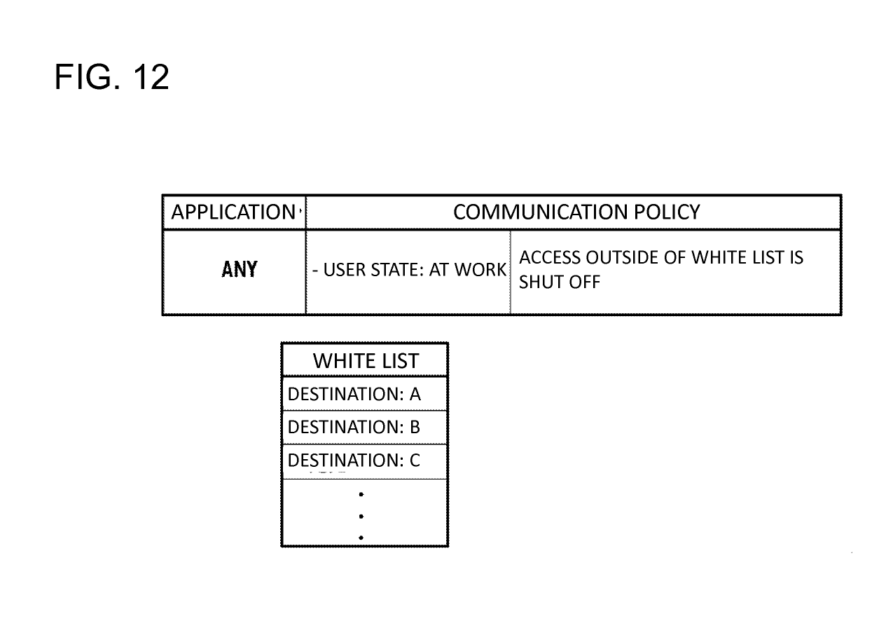

FIG. 12 shows an example of a communication policy in the sixth exemplary embodiment.

In the example of FIG. 12, “ANY” is shown in the “application” column. This means all applications that perform communication by the communication terminal 1.

In accordance with communication policy, with regard to communications by all applications, a communication unit 11 shuts off access to destinations outside a white list, for example, in a case where a user state is at-work. The communication unit 11, for example, holds the white list as exemplified in FIG. 12, and shuts off communication to destinations outside of those included in the white list.

### Seventh Exemplary Embodiment

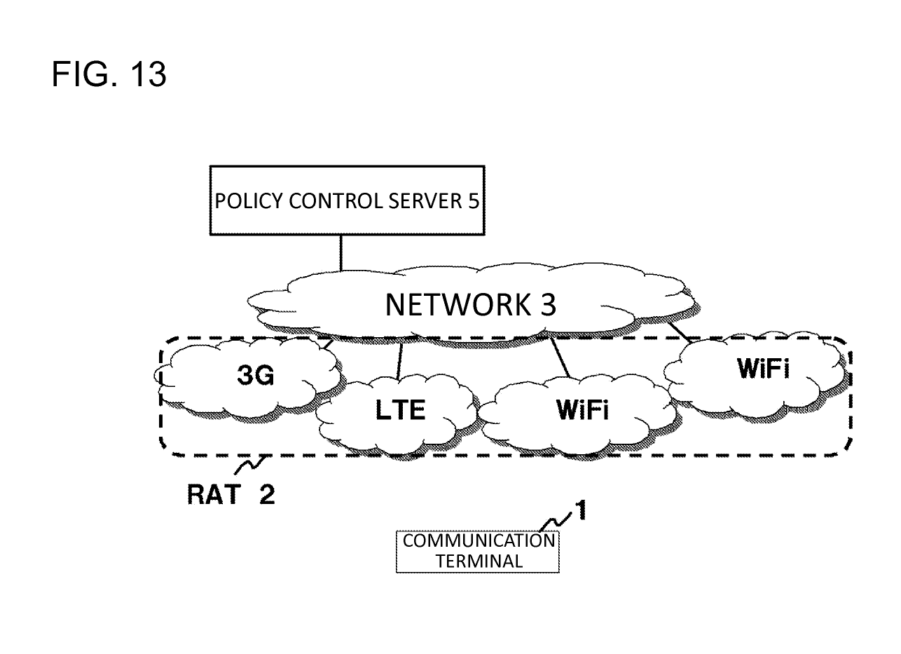

A description is given of a seventh exemplary embodiment of the present invention, making reference to FIG. 13. In the seventh exemplary embodiment, a policy control server 5 notifies information related to communication policy, to a communication terminal 1. Since the policy control server 5 notifies information related to communication policy to the communication terminal 1 via a network, for a user of the communication terminal 1, operations such as setting information related to communication policy and the like in a terminal are made open. A system administrator of a company can centrally control work-related usage by a privately owned terminal, via the policy control server 5, and administration related to information security is facilitated.

The seventh exemplary embodiment can be applied to any of the abovementioned exemplary embodiments.

A communication system in the seventh exemplary embodiment, as shown in FIG. 13, includes the communication terminal 1, a RAT 2, a network 3 and the policy control server 5.

The policy control server 5, for example, is disposed in an in-company intranet, and can communicate via the intranet with the communication terminal 1 that is connected to the in-company intranet. The policy control server 5 can communicate via the network 3 (for example, the Internet) with the communication terminal 1 that is connected to an external network. It is to be noted that the location at which the policy notification server 5 is disposed is not limited to an in-company intranet, and may be any position, such as a data center that can communicate with the communication terminal 1 via the network 3.

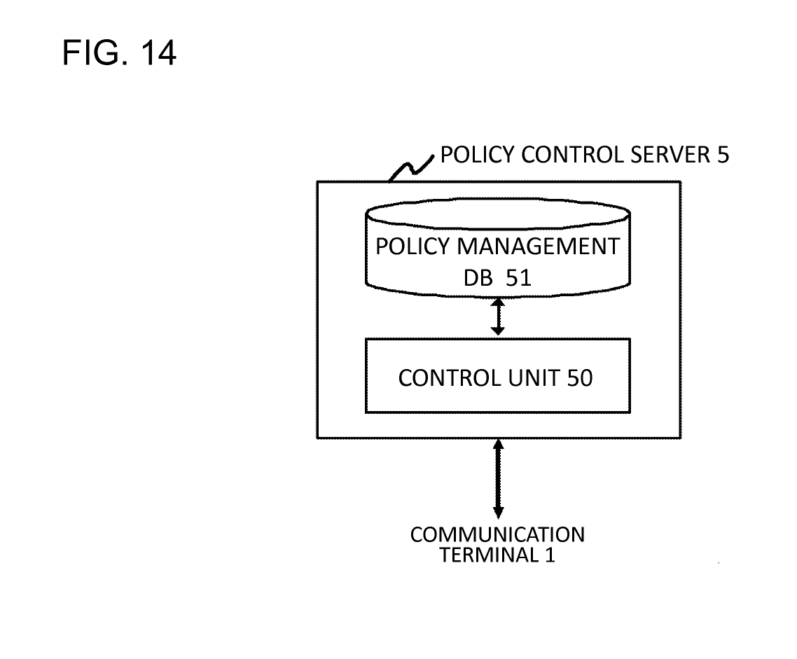

FIG. 14 shows a configuration example of the policy control server 5 in the seventh exemplary embodiment of the invention. The policy control server 5 is provided with a control unit 50 and a policy management DB (Data Base) 51.

The policy management DB 51, for example, is a database to manage information related to communication policy as exemplified in the abovementioned exemplary embodiments (for example, FIGS. 3, 5, 6, 7, 8, 10, 11 and 12. For example, a company administrator stores information related to communication policy in the policy management DB 51.

The control unit 50, for example, manages a privately owned communication terminal 1 connected to an in-company intranet. For example, a user of the communication terminal 1 registers identification information such as the telephone number of the communication terminal 1 or IMSI (International Mobile Subscriber Identity) in the policy control server 5. The control unit 50 collates identification information of a terminal connected inside a company and registered identification information, and recognizes the privately owned communication terminal 1 that is connected to an in-company intranet. In a case where the policy control server 5 is disposed in an external data center, the policy control server 5, for example, collates identification information of the communication terminal 1 that makes a request for a connection to the policy control server 5, and identification information registered in the policy control server 5, and identifies whether or not the terminal that has made the request for a connection is a terminal to which communication policy is to be notified.

The control unit 50 has a function of communicating with the communication terminal 1. The control unit 50, for example, notifies information related to updated communication policy to the communication terminal 1, in response to the policy management DB 51 being updated. The control unit 50, for example, notifies information related to communication policy to the communication terminal 1, according to a prescribed period.

### Eighth Exemplary Embodiment

An eighth exemplary embodiment of the present invention shows an example in which the present invention is implemented by making an improvement to technology known as OpenFlow, which is a centrally controlled network architecture.

The eighth exemplary embodiment can be applied to any of the abovementioned exemplary embodiments.

OpenFlow recognizes communication as end-to-end flow, and can execute path control on a per-flow basis.

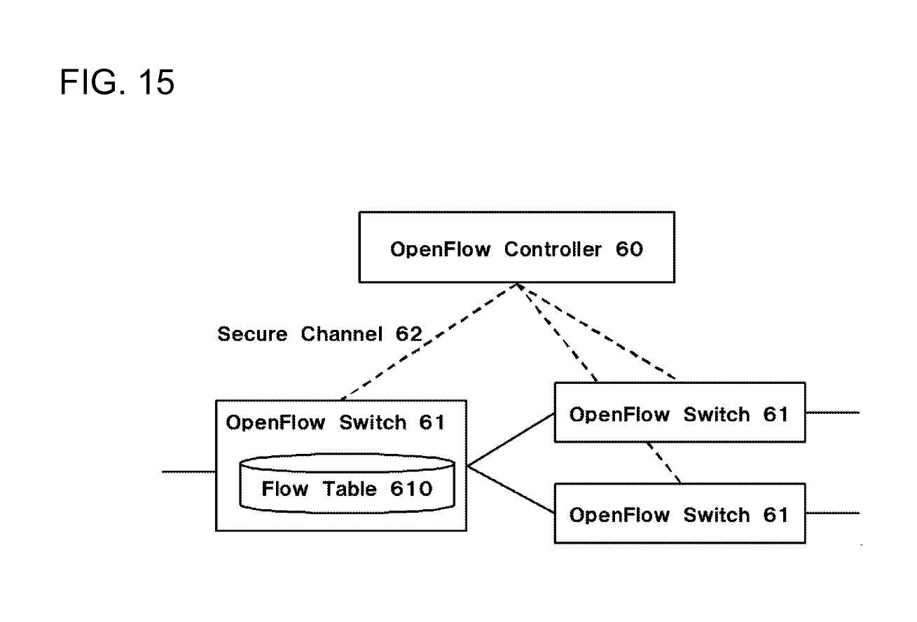

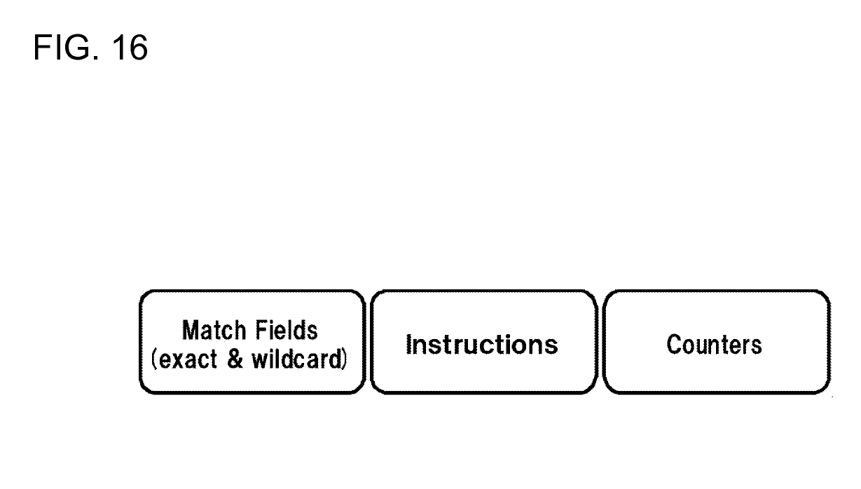

A description is given concerning OpenFlow, making reference to FIG. 15 and FIG. 16.

FIG. 15 illustrates an outline of a communication system configured according to OpenFlow technology. It is to be noted that a flow is, for example, a group of serial communication packets having prescribed attributes (attributes identified based on communication destination, transmission source, or the like). An OpenFlow switch 61 is a network switch used in OpenFlow technology. An OpenFlow controller 60 is an information processing apparatus that controls the OpenFlow switch 61.

The OpenFlow switch 61 communicates with the OpenFlow controller 60 via a secure channel 62 disposed between the OpenFlow switch 61 and the OpenFlow controller 60. The OpenFlow controller 60 performs setting of a flow table 610 of the OpenFlow switch 61, via the secure channel 62. It is to be noted that the secure channel 62 is a communication path disposed in order to prevent interception or manipulation of communication between the switch and the controller.

FIG. 16 shows a configuration example of respective entries (flow entries) of the flow table 610. Flow entries 610 are configured by a matching rule (Match Fields) for collating information (for example, destination IP address or VLAN ID) included in a header of a packet received by a switch, statistical information (Counters) which is statistical information for each packet flow, and instructions (Instructions) that prescribe a processing method for packets matching the matching rule.

On receiving a packet, the Open Flow switch 61 refers to the flow table 610. The OpenFlow switch 61 searches for a flow entry matching header information of the received packet. In a case where an entry that matches the header information of the received packet is found, the OpenFlow switch 61 processes the received packet in accordance with a processing method defined in an instruction field of the retrieved entry. The processing method prescribes, for example, “forward received packet from prescribed port,” “drop received packet,” “rewrite part of header of received packet and forward from prescribed port.”

On the other hand, in a case where an entry that matches the header information of the received packet is not found, the OpenFlow switch 61, for example, forwards the received packet to the OpenFlow controller 60 via the secure channel 62. The OpenFlow switch 61 requests setting of a flow entry defining a processing method for the received packet, with regard to the OpenFlow controller 60, by forwarding the received packet. As a packet processing method, in a case where a packet matches a flow entry prescribing that a request be forwarded to the controller, the OpenFlow switch 61 may request the controller to set a flow entry in accordance with the processing method.

The OpenFlow controller 60 determines the processing method for a received packet and sets a flow entry including the determined processing method in the flow table 610. Thereafter, the OpenFlow switch 61 processes subsequent packets belonging to the same flow as the received packet, in accordance with the set flow entry.

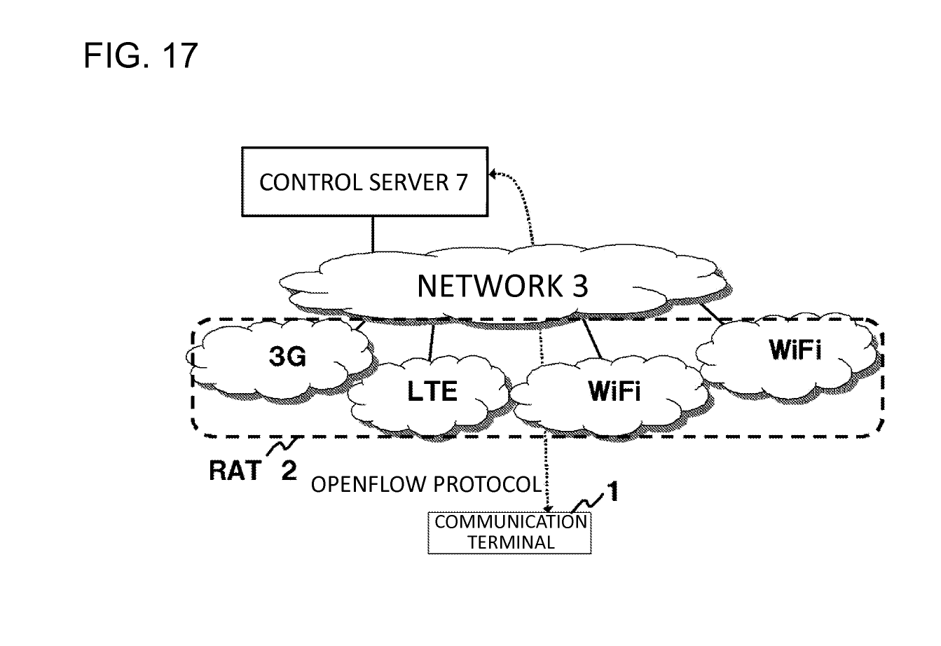

FIG. 17 shows an example of a communication system in the eighth exemplary embodiment of the invention. The eighth exemplary embodiment of the invention includes a communication terminal 1, a RAT 2, a network 3, and a control server 7, as shown in FIG. 17. The control server 7 can communicate with the communication terminal 1 in accordance with Open Flow protocol.

The control server 7, for example, is disposed in an in-company intranet, and can communicate via the intranet with the communication terminal 1 that is connected to the in-company intranet. The control server 7 can communicate via the network 3 (for example, the Internet) with the communication terminal 1 that is connected to an external network. It is to be noted that the location at which the control server 7 is disposed is not limited to an in-company intranet, and may be at any position, such as a data center that can communicate with the communication terminal 1 via the network 3.

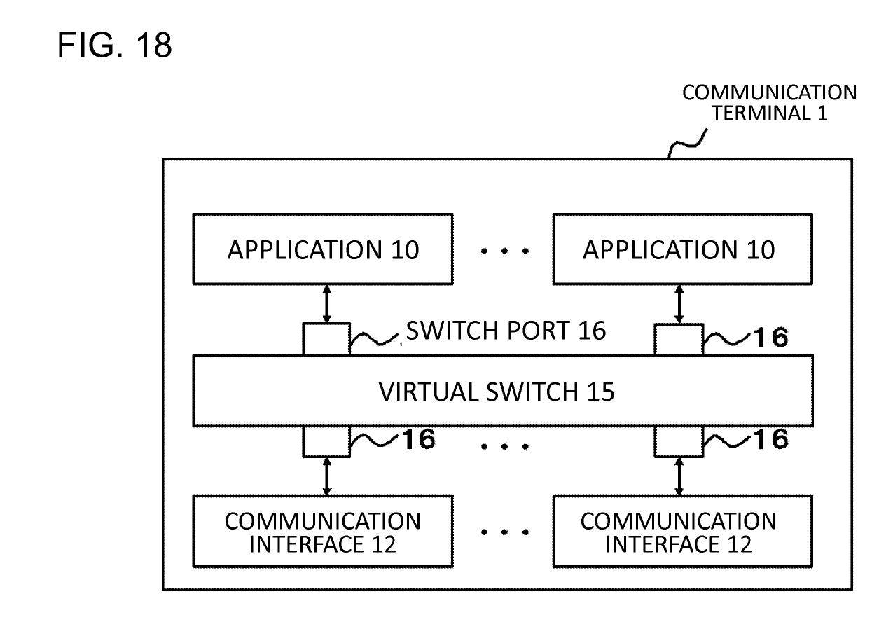

FIG. 18 is a diagram showing a configuration example of the communication terminal 1 in the eighth exemplary embodiment of the invention. The communication terminal 1 has a plurality of applications 10, a plurality of communication interfaces 12, a virtual switch 15, and a plurality of switch ports 16.

The communication terminal 1 has the virtual switch 15, which is configured by improving an Open Flow switch. The virtual switch 15 is configured by software, but the present invention may also be configured by hardware.

The virtual switch 15 has functionality similar to the communication unit 11 exemplified in FIG. 2. Furthermore, the virtual switch 15 has functionality for operating in response to an instruction transmitted from the control server 7.

Each application 10 is connected to a switch port 16. Each communication interface 12 is connected to a switch port 16. The virtual switch 15 forwards packets transmitted from the respective applications in accordance with an instruction from the control server 7, from a switch port 16 corresponding to a communication interface 12 selected for use in communication by the relevant application. In a case of receiving packets addressed to respective applications, the virtual switch 15 forwards the relevant packets to the switch port 16 corresponding to the destination application.

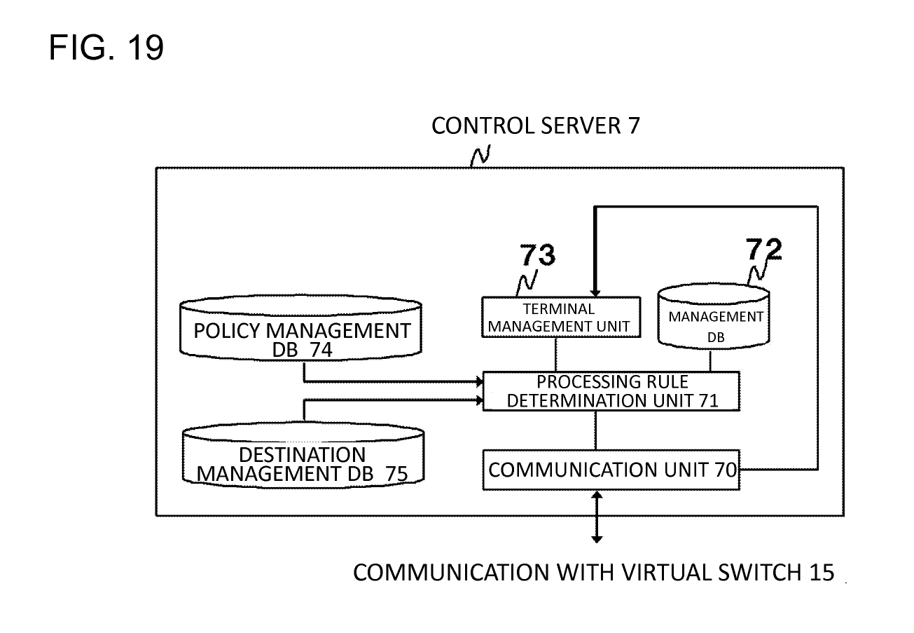

FIG. 19 shows an example of a configuration of the control server 7.

The control server 7 includes a communication unit 70, a processing rule determination unit 71, a management DB 72, a terminal management unit 73, a policy management DB 74 and a destination management DB 75.

The communication unit 70 has a function for communicating with the communication terminal 1 based on an Open Flow protocol. The communication unit 70 receives a request for a packet processing rule (corresponding to the “flow entry” described above), from the communication unit 1. The communication unit 70 notifies the processing rule to the communication terminal 1.

A policy management DB 74, for example, is a database to manage information related to communication policy as exemplified in the abovementioned exemplary embodiments (for example, FIGS. 3, 5, 6, 7, 8, 10, 11 and 12). For example, a company administrator stores information related to communication policy in the policy management DB 74.

A destination management DB 75, for example, manages destinations (IP address or URL) of Web sites or servers (file server or mail server, etc.) of an in-company intranet which may be accessed by the communication terminal 1. The destination management DB 75 may manage a white list described in the sixth exemplary embodiment.

The terminal management unit 73, for example, manages the communication terminal 1 that is privately owned and is connected to an in-company intranet. For example, a user of the communication terminal 1 registers identification information such as the telephone number of the communication terminal 1 or IMSI, in the control server 7. The terminal management unit 73 collates identification information of a terminal connected within a company and registered identification information, and recognizes the privately owned communication terminal 1 that is connected to the in-company intranet. In a case where the control server 7 is disposed in an external data center, the control server 7, for example, collates identification information of the communication terminal 1 that has made a request for a connection to the control server 7, and identification information registered in the control server 7, and identifies whether or not the terminal that has made the request for a connection is a terminal to which communication policy is to be notified.

The terminal management unit 73, for example, manages an SSID of access points of a wireless LAN that the respective communication terminals 1 can connect to, location information of each communication terminal 1, and information related to applications installed in the respective communication terminals 1 (for example, application identifiers). The terminal management unit 73, for example, transmits collected requests for this information to the communication terminals 1, and collects the information. The terminal management unit 73, for example, collects information from the communication terminals 1 at prescribed periods.

The terminal management unit 73, for example, manages connection relationships of switch ports 16 and applications, with regard to each communication terminal 1. Furthermore, the terminal management unit 73, for example, manages connection relationships of switch ports 16 and communication interfaces 12, with regard to each communication terminal 1.

Communication equipment (network switches and the like) conforming to OpenFlow has functionality (Port Status) that notifies the status of ports of the communication equipment to the controller, and functionality (Feature Request/Reply) that notifies switch features to the controller. The terminal management unit 73 may collect information from the communication terminals 1 by these functions.

The processing rule determination unit 71 determines processing rules to be set in a virtual switch 15 of the communication terminals 1. The processing rule determination unit 71 refers to information held by the policy management DB 74, the destination management DB 75, and the terminal management unit 73, and generates processing rules corresponding to communication policy. The processing rule determination unit 71, for example, recognizes applications installed in the respective communication terminals 1, from information held by the terminal management unit 73. The processing rule determination unit 71, for example, generates processing rules corresponding to applications for which an operation instruction according to communication policy is necessary, among applications installed in the respective communication terminals 1.

The processing rule determination unit 71, for example, generates matching rules for the processing rules, based on conditions specified in the communication policy. For example, the processing rule determination unit 71 generates a matching rule using a port number (for example, port number “80” in the case of HTTP communication by a Web browser) as set in the respective applications, in order to identify communication from the respective applications. Furthermore, the processing rule determination unit uses a communication destination address (for example, whether addressed to an in-company intranet or not) as a matching rule corresponding to a communication usage mode (for example, whether or not the communication is work-related). The processing rule determination unit 71 refers to the destination management DB 75, recognizes an in-company intranet destination, and generates a matching rule.

The processing rule determination unit 71 generates a processing method for packets corresponding to the generated matching rule, based on the communication policy. For example, the processing rule determination unit 71 refers to the communication policy and generates a processing method to forward packets to a switch port 16 to which a communication interface 12 corresponding to the matching rule is connected.

The processing rule determination unit 71, for example, periodically refers to information held by the terminal management unit 73, and in a case of detecting a status change of a user or the communication terminal 1 (for example, a change in access point to which connection is possible, a change in location, etc.), generates a processing rule corresponding to the status change.

The processing rule determination unit 71 stores the generated processing rule in the management DB 75.

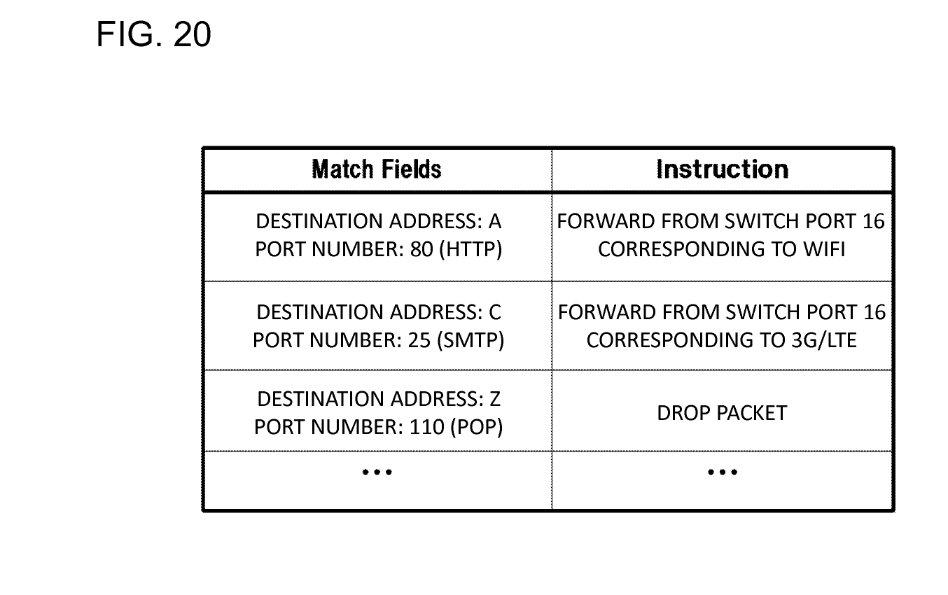

FIG. 20 shows an example of a processing rule generated by the processing rule determination unit 71.

In the example of FIG. 20, a matching rule of the first line of the processing rule is “for destination address ‘A,’ port number is ‘80.’” The destination address of “A” is taken as being a Web site in an in-company intranet. In this case, the matching rule “for destination address ‘A,’ port number is ‘80’” corresponds to a usage mode of “work-related communication directed to in-company intranet.” An instruction of the first line of the processing rule indicates forwarding of packets to a switch port 16 corresponding to WiFi. With regard to the communication terminal 1, assuming that it is possible to connect to a wireless LAN access point of the in-company intranet, this instruction indicates executing a work-related communication via the wireless LAN access point of the in-company intranet.

In a case where access to the in-company intranet is denied, as shown in the third line of FIG. 20 for example, a processing rule prescribing an instruction to drop the packet is generated. For example, in a case of a communication policy rejecting a POP received communication from an in-company mail server by a privately owned communication terminal 1, the processing rule determination unit 71 generates a processing rule “for flow corresponding to communication with an in-company POP server, packet is dropped.”

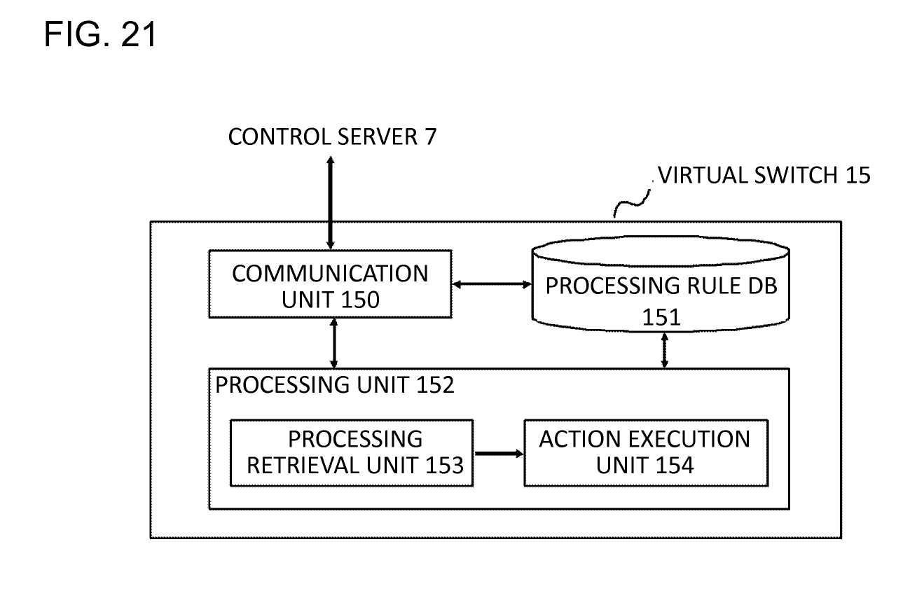

FIG. 21 shows an example of a configuration of a virtual switch 15. As shown in FIG. 21, the virtual switch 15 has a communication unit 150, a processing rule DB 151, and a processing unit 152. The processing unit 152 has a processing retrieval unit 153 and an action execution unit 154.

The communication unit 150 communicates with the control server 7, in accordance with an Open Flow protocol.

The processing rule DB 151 stores processing rules notified by the control server 7.

The processing unit 152 processes packets in accordance with a processing rule notified by the control server 7.

The processing retrieval unit 153 retrieves a processing rule corresponding to a received packet from the processing rule DB 151. The processing retrieval unit 153 collates packets and “Matching Field” of a processing rule stored in the processing rule DB 151, and retrieves a processing rule corresponding to the packet.

The action execution unit 154 processes the packet in accordance with a processing method prescribed in an “Instruction” field of the retrieved processing rule.

In a case where a processing rule corresponding to a received packet does not exist in the processing rule DB 151, for example, the processing retrieval unit 153 makes a request to the control server 7 to set a processing rule.

A description has been given above of exemplary embodiments of the present invention, but the present invention is not limited to the respective exemplary embodiments described above. The present invention may be implemented with modifications, substitutions or adjustments to the respective exemplary embodiments. Furthermore, the invention may be implemented by any combination of the respective exemplary embodiments. That is, the present invention includes every type of transformation and modification that may be realized according to the entire disclosure of the present specification and to technological concepts thereof. It is to be noted that the following modes are possible in the present invention.

### (Mode 1)

A communication terminal that can communicate through a plurality of communication schemes, the terminal comprising:

a plurality of communication interfaces that correspond to at least one of the plurality of communication schemes; and
a communication unit that stores a plurality of communication policies associated respectively with a plurality of applications, and that selects a communication interface(s) to be used in communication performed respectively by the plurality of applications, in accordance with the plurality of communication policies that include a condition(s) identifying of a usage mode of the communication.

### (Mode 2)

The communication terminal according to mode 1, wherein the communication unit establishes a connection to prevent an information leak, in accordance with at least one of the plurality of communication policies.

### (Mode 3)

The communication terminal according to mode 1 or 2, wherein the plurality of communication policies include a required condition with regard to communication performed respectively by the plurality of applications, and

the communication unit can select in accordance with the required condition a communication interface(s) to be used in communication performed respectively by plurality of applications.

### (Mode 4)

The communication terminal according to any one of modes 1 to 3, wherein

the plurality of communication policies include a condition related to a work state of a user of the communication terminal, and the communication unit can select in accordance with the condition a communication interface(s) to be used in communication performed respectively by the plurality of applications.

### (Mode 5)

The communication terminal according to any one of modes 1 to 4, wherein

the communication unit can shut off communication in accordance with at least one of the plurality of communication policies.

### (Mode 6)

The communication terminal according to any one of modes 1 to 5, wherein

the plurality of communication policies include a condition for judging whether communication performed respectively by the plurality of applications is permitted or not, and
the communication unit can shut off the communication in accordance with the condition.

### (Mode 7)

The communication terminal according to mode 5 or 6, wherein the communication unit can notify at least one of an administrator and a user of the communication terminal of detection of communication to be shut off in accordance with at least one of the plurality of communication policies.

### (Mode 8)

A communication method, by a communication terminal that comprises a plurality of communication interfaces corresponding to at least one of a plurality of communication schemes, the method comprising:

referring to a plurality of communication policies associated respectively with a plurality of applications; and
selecting a communication interface(s) to be used in communication performed respectively by the plurality of applications, in accordance with the plurality of communication policies that include a condition(s) identifying of a usage mode of the communication.

### (Mode 9)

The communication method according to mode 8, comprising:

establishing a connection to prevent an information leak in accordance with at least one of the plurality of communication policies.

### (Mode 10)

The communication method according to mode 8 or 9, comprising:

referring to the plurality of communication policies that include a required condition with regard to communication performed respectively by the plurality of applications, and
selecting in accordance with the required condition a communication interface(s) to be used in communication performed respectively by the plurality of applications.

### (Mode 11)

The communication method according to any one of modes 8 to 10, comprising:

referring to the plurality of communication policies that include a condition related to a work state of a user of the communication terminal, and
selecting in accordance with the condition a communication interface(s) to be used in communication performed respectively by the plurality of applications.

### (Mode 12)

The communication method according to any one of modes 8 to 11, comprising:

shutting off communication in accordance with at least one of the plurality of communication policies.

### (Mode 13)

The communication method according to any one of modes 8 to 12, comprising:

referring to the plurality of communication policies that include a condition for judging whether communication performed respectively by the plurality of applications is permitted or not, and shutting off the communication in accordance with the condition.

### (Mode 14)

The communication method according to either mode 12 or 13, comprising:

notifying at least one of an administrator and a user of the communication terminal of detection of communication to be shut off in accordance with at least one of the plurality of communication policies.

### (Mode 15)

A program, causing a communication terminal that comprises a plurality of communication interfaces corresponding to at least one of a plurality of communication schemes to execute:

referring to a plurality of communication policies associated respectively with a plurality of applications, and
selecting a communication interface(s) to be used in communication performed respectively by the plurality of applications, in accordance with the plurality of communication policies that include a condition(s) identifying a usage mode of the communication.

### (Mode 16)

A communication system, including a communication terminal that can communicate through a plurality of communication schemes, wherein

the communication terminal comprises:
a plurality of communication interfaces that correspond to at least one of the plurality of communication schemes; and
a communication unit that stores a plurality of communication policies associated respectively with a plurality of applications, and that can select a communication interface(s) to be used in communication performed respectively by the plurality of applications, in accordance with the plurality of communication policies that include a condition(s) identifying of a usage mode of the communication.

### (Mode 17)

An information processing apparatus that can communicate with a communication terminal that comprises a plurality of communication interfaces corresponding to at least one of a plurality of communication schemes, the information processing apparatus comprising:

a storage unit that stores a plurality of communication policies associated respectively with a plurality of applications that operate on the communication terminal, and
a control unit that generates an instruction for causing the communication terminal to execute selecting a communication interface(s) to be used in communication performed respectively by the plurality of applications, in accordance with the plurality of communication policies that include a condition(s) identifying of a usage mode of the communication.

### (Mode 18)

The information processing apparatus according to mode 17, wherein

the control unit generates an instruction for causing the communication terminal to execute establishing a connection to prevent an information leak, in accordance with at least one of the plurality of communication policies.

### (Mode 19)

The information processing apparatus according to mode 17 or 18, wherein

the plurality of communication policies include a required condition with regard to communication performed respectively by the plurality of applications, and the control unit generates an instruction for causing the communication terminal to execute selecting in accordance with the required condition a communication interface(s) to be used in communication performed respectively by the plurality of applications.

### (Mode 20)

The information processing apparatus according to any one of modes 17 to 19, wherein

the plurality of communication policies include a condition related to a work state of a user of the communication terminal, and
the control unit generates an instruction for causing the communication terminal to execute selecting in accordance with the condition a communication interface(s) to be used in communication performed respectively by the plurality of applications.

### (Mode 21)

The information processing apparatus according to any one of modes 17 to 20, wherein

the control unit generates an instruction for causing the communication terminal to execute shutting off communication in accordance with at least one of the plurality of communication policies.

### (Mode 22)

The information processing apparatus according to any one of modes 17 to 21, wherein

the plurality of communication policies include a condition for judging whether communication performed respectively by the plurality of applications is permitted or not, and the control unit generates an instruction for causing the communication terminal to execute shutting off the communication in accordance with the condition.
1 communication terminal
2 RAT
3 network
4 VPN server
5 policy control server
7 control server
10 application
11 communication unit
12 communication interface
15 virtual switch
16 switch port
50 control unit
51 policy management DB
60 OpenFlow controller
61 OpenFlow switch
62 secure channel
70 communication unit
71 processing rule determination unit
72 management DB
73 terminal management unit
74 policy management DB
75 destination management DB
150 communication unit
151 processing rule DB
152 processing unit
153 processing retrieval unit
154 action execution unit
610 flow table

What is claimed is:

1. A communication terminal that can communicate through a plurality of communication schemes, the terminal comprising:
a plurality of communication interfaces that correspond to at least one of the plurality of communication schemes; and
a communication unit that stores a plurality of communication policies associated respectively with a plurality of applications, and that selects, from the plurality of communication interfaces, a communication interface(s) to be used in communication performed respectively by the plurality of applications, in accordance with the plurality of communication policies that include a condition(s) identifying of a usage mode of the communication.

2. The communication terminal according to claim 1, wherein
the communication unit establishes a connection to prevent an information leak, in accordance with at least one of the plurality of communication policies.

3. The communication terminal according to claim 1, wherein
the plurality of communication policies include a required condition with regard to communication performed respectively by the plurality of applications, and
the communication unit selects in accordance with the required condition a communication interface(s) to be used in communication performed respectively by plurality of applications from the plurality of communication interfaces.

4. The communication terminal according to claim 1, wherein
the plurality of communication policies include a condition related to a work state of a user of the communication terminal, and
the communication unit selects in accordance with the condition a communication interface(s) to be used in communication performed respectively by the plurality of applications from the plurality of communication interfaces.

5. The communication terminal according to claim 1, wherein
the communication unit shuts off communication in accordance with at least one of the plurality of communication policies.

6. The communication terminal according to claim 1, wherein
the plurality of communication policies include a condition for judging whether communication performed respectively by the plurality of applications is permitted or not, and
the communication unit shuts off the communication in accordance with the condition.

7. The communication terminal according to claim 5, wherein
the communication unit notifies at least one of an administrator and a user of the communication terminal of detection of communication to be shut off in accordance with at least one of the plurality of communication policies.

8. A communication method, by a communication terminal that comprises a plurality of communication interfaces corresponding to at least one of a plurality of communication schemes, the method comprising:
referring to a plurality of communication policies associated respectively with a plurality of applications; and
selecting, from the plurality of communication interfaces, a communication interface(s) to be used in communication performed respectively by the plurality of applications, in accordance with the plurality of communication policies that include a condition(s) identifying of a usage mode of the communication.

9. The communication method according to claim 8, comprising:
establishing a connection to prevent an information leak in accordance with at least one of the plurality of communication policies.

10. The communication method according to claim 8, comprising:
referring to the plurality of communication policies that include a required condition with regard to communication performed respectively by the plurality of applications, and
selecting in accordance with the required condition a communication interface(s) to be used in communication performed respectively by the plurality of applications from the plurality of communication interfaces.

11. The communication method according to claim 8, comprising:
referring to the plurality of communication policies that include a condition related to a work state of a user of the communication terminal, and
selecting in accordance with the condition a communication interface(s) to be used in communication performed respectively by the plurality of applications from the plurality of communication interfaces.

12. The communication method according to claim 8, comprising:
shutting off communication in accordance with at least one of the plurality of communication policies.

13. The communication method according to claim 8, comprising:
referring to the plurality of communication policies that include a condition for judging whether communication performed respectively by the plurality of applications is permitted or not, and
shutting off the communication in accordance with the condition.

14. The communication method according to claim 12, comprising:
notifying at least one of an administrator and a user of the communication terminal of detection of communication to be shut off in accordance with at least one of the plurality of communication policies.

15. A non-transitory computer-readable recording medium, storing a program that causes a communication terminal that comprises a plurality of communication interfaces corresponding to at least one of a plurality of communication schemes to execute:
referring to a plurality of communication policies associated respectively with a plurality of applications, and
selecting, from the plurality of communication interfaces, a communication interface(s) to be used in communication performed respectively by the plurality of applications, in accordance with the plurality of communication policies that include a condition(s) identifying a usage mode of the communication.

16. A communication system, including a communication terminal that can communicate through a plurality of communication schemes, wherein
the communication terminal comprises:
a plurality of communication interfaces that correspond to at least one of the plurality of communication schemes; and
a communication unit that stores a plurality of communication policies associated respectively with a plurality of applications, and that selects, from the plurality of communication interfaces, a communication interface(s) to be used in communication performed respectively by the plurality of applications, in accordance with the plurality of communication policies that include a condition(s) identifying of a usage mode of the communication.

17. An information processing apparatus that can communicate with a communication terminal that comprises a plurality of communication interfaces corresponding to at least one of a plurality of communication schemes, the information processing apparatus comprising:
a storage unit that stores a plurality of communication policies associated respectively with a plurality of applications that operate on the communication terminal, and
a control unit that generates an instruction for causing the communication terminal to execute selecting, from the plurality of communication interfaces, a communication interface(s) to be used in communication performed respectively by the plurality of applications, in accordance with the plurality of communication policies that include a condition(s) identifying of a usage mode of the communication.

18. The information processing apparatus according to claim 17, wherein
the control unit generates an instruction for causing the communication terminal to execute establishing a connection to prevent an information leak, in accordance with at least one of the plurality of communication policies.

19. The information processing apparatus according to claim 17, wherein
the plurality of communication policies include a required condition with regard to communication performed respectively by the plurality of applications, and
the control unit generates an instruction for causing the communication terminal to execute selecting in accordance with the required condition a communication interface(s) to be used in communication performed respectively by the plurality of applications from the plurality of communication interfaces.

20. The information processing apparatus according to claim 17, wherein
the plurality of communication policies include a condition related to a work state of a user of the communication terminal, and
the control unit generates an instruction for causing the communication terminal to execute selecting in accordance with the condition a communication interface(s) to be used in communication performed respectively by the plurality of applications from the plurality of communication interfaces.

21. The information processing apparatus according to claim 17, wherein
the control unit generates an instruction for causing the communication terminal to execute shutting off communication in accordance with at least one of the plurality of communication policies.

22. The information processing apparatus according to claim 17, wherein
the plurality of communication policies include a condition for judging whether communication performed respectively by the plurality of applications is permitted or not, and
the control unit generates an instruction for causing the communication terminal to execute shutting off the communication in accordance with the condition.

23. The information processing apparatus according to claim 21, wherein
the control unit generates an instruction for causing the communication terminal to execute notifying at least one of an administrator and a user of the communication terminal of detection of communication to be shut off in accordance with at least one of the plurality of communication policies.
